(19) United States
(12) Patent Application Publication
(10) Pub. No.: US 2011/0008013 A1
(43) Pub. Date: Jan. 13, 2011

(54) METHOD FOR CONTROLLING AN AUDIO/VIDEO PLAYER TO PLAY BACK AUDIO BACKGROUND, AND ASSOCIATED AUDIO/VIDEO PLAYER

(76) Inventors: Ping Zhao, Hefei (CN); Jie Liu, Hefei City (CN)

Correspondence Address: NORTH AMERICA INTELLECTUAL PROPERTY CORPORATION, P.O. BOX 506, MERRIFIELD, VA, 22116, US

(21) Appl. No.: 12/545,078

(22) Filed: Aug. 21, 2009

(30) Foreign Application Priority Data
Jul. 10, 2009 (CN) 200910157516.6

(51) Int. Cl. H04N 5/91

(52) U.S. Cl. 386/241; 386/285

(57) ABSTRACT

A method for controlling an audio/video player to play back audio background includes: after a storage medium storing at least one still image file is loaded into the audio/video player, searching for an audio file corresponding to the still image file; and selectively playing back the audio file as the audio background during playing back of the still image file. An audio/video player includes: at least one loading module arranged to load at least one storage medium into the audio/video player; and a control circuit. After a storage medium storing at least one still image file is loaded into the audio/video player, the control circuit searches for an audio file corresponding to the still image file, and selectively plays back the audio file as audio background during playing back of the still image file when the audio file exists in the storage medium.

### BACKGROUND

The present invention relates to audio/video playback devices, and more particularly, to a method for controlling an audio/video player to play back audio background, and to an associated audio/video player.

A conventional audio/video playback device such as a digital versatile disc (DVD) player launched on the market can be utilized for playing back still image files stored in an optical disc. For example, the optical disc can be a recordable type optical disc such as a compact disc-recordable (CD-R) disc, a DVD+R disc or a DVD-R disc, and the still image files can be stored in the optical disc utilizing the Joint Photographic Experts Group (JPEG) format.

Regarding methods of obtaining the optical disc storing the still image files, disc editing programs have not been largely welcomed by users since disc editing programs are complicated and take too much time to use. As a result, the optical disc storing still image files is typically derived from a file backup process of a personal computer (PC). A user may obtain the still image files from a digital still image camera, and further utilize an optical disc drive of the PC to backup the still image files into a blank disc in order to obtain the aforementioned optical disc storing the still image files. The file backup process mentioned above can be easily accomplished by simply putting the blank disc in a disc tray of an optical disc drive and giving one or a few instructions.

According to the related art, when the optical disc is loaded into the conventional DVD player, the conventional DVD player can be triggered to play back the still image files in sequence. The still image files are typically played back silently since there is no audio information in each still image file. Thus, when a user views the still image files, an uncomfortable atmosphere may arise due to the quietness of the playing back operation, particularly in situations where the pictures generate some emotional response. As a result, the conventional DVD player can give an unpleasant viewing experience to the user.

### SUMMARY

It is therefore an objective of the claimed invention to provide a method for controlling an audio/video player to play back audio background, and to provide an associated audio/video player, in order to solve the above-mentioned problem.

An exemplary embodiment of a method for controlling an audio/video player to play back audio background comprises: after a storage medium storing at least one still image file is loaded into the audio/video player, searching for an audio file corresponding to the still image file; and selectively playing back the audio file as the audio background during playing back of the still image file when the audio file exists in the storage medium.

An exemplary embodiment of an audio/video player comprises: at least one loading module arranged to load at least one storage medium into the audio/video player; and a control circuit arranged to control operations of the audio/video player. In addition, after a storage medium storing at least one still image file is loaded into the audio/video player, the control circuit searches for an audio file corresponding to the still image file. Additionally, the control circuit selectively plays back the audio file as audio background during playing back of the still image file when the audio file exists in the storage medium.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an audio/video player according to a first embodiment of the present invention.

FIG. 2 is a flowchart of a method for controlling an audio/video player to play back audio background according to one embodiment of the present invention.

FIG. 3 is a diagram of an audio/video player according to a second embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

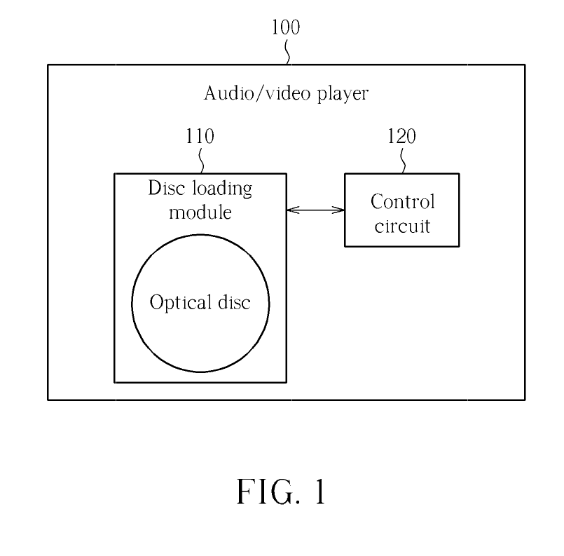

Please refer to FIG. 1, which shows a diagram of an audio/video player 100 according to a first embodiment of the present invention. In this embodiment, the audio/video player 100 is an optical disc player such as a digital versatile disc (DVD) player. The audio/video player 100 comprises at least one loading module arranged to load at least one storage medium into the audio/video player 100, where the loading module of this embodiment is a disc loading module 110 for loading an optical disc into the audio/video player 100. In addition, the audio/video player 100 further comprises a control circuit 120 arranged to control operations of the audio/video player 100.

According to this embodiment, when an optical disc storing a plurality of still image files is loaded into the audio/video player 100, the audio/video player 100 of this embodiment can be triggered to play back the still image files in sequence. Here, the optical disc storing the still image file can be a recordable/rewritable type optical disc derived from a file backup process of a personal computer (PC).

For example, the optical disc can be a recordable type optical disc such as a compact disc-recordable (CD-R) disc, a DVD+R disc or a DVD-R disc. In another example, the optical disc can be a rewritable type optical disc such as a compact disc-rewritable (CD-RW) disc, a DVD+RW disc or a DVD-RW disc. In addition, the still image files can be stored in the optical disc utilizing the Joint Photographic Experts Group (JPEG) format mentioned above.

Please note that the audio/video player 100 of this embodiment can be further triggered to play back at least one audio file as audio background during playing back of the still image files. As the still image files are not played back silently, a user viewing the still image files by utilizing the audio/video player 100 will not experience the silent atmosphere of the playing back operation of the conventional DVD player. Therefore, in a situation where the user is alone with some memorable scenes being displayed, the audio/video player 100 will give a pleasant viewing experience to the user.

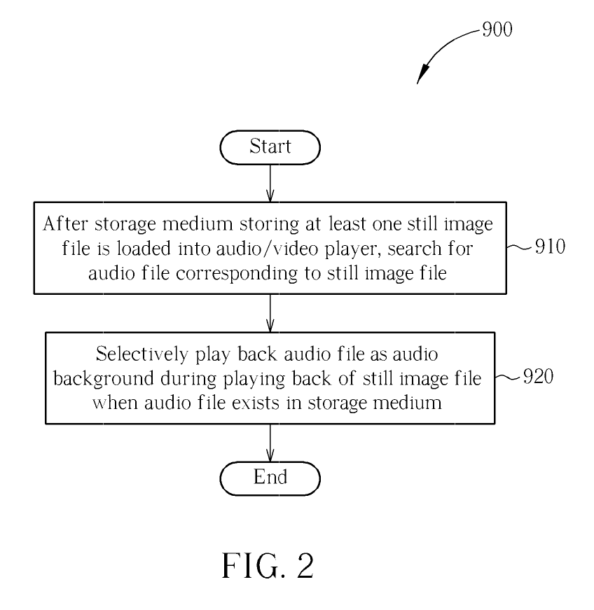

FIG. 2 is a flowchart of a method 900 for controlling an audio/video player to play back audio background according to one embodiment of the present invention. The method 900 can be applied to the audio/video player 100, and can be implemented with the audio/video player 100. The method 900 is described as follows.

In Step 910, after a storage medium storing at least one still image file, such as the aforementioned recordable/rewritable type optical disc derived from the file backup process of the PC, is loaded into the audio/video player 100 through the disc loading module 110, the control circuit 120 searches for an audio file corresponding to the still image file. In particular, in a situation where the storage medium stores a plurality of still image files such as those stored in the aforementioned recordable/rewritable type optical disc, the control circuit 120 searches for an audio file corresponding to the still image files.

In practice, the control circuit 120 is provided with some searching strategies. Some examples are described below. According to a first strategy, in the storage medium, the control circuit 120 searches for the audio file in a directory of a predetermined name. According to a second strategy, in the storage medium, the control circuit 120 searches for the audio file in a directory where the still image file is stored. According to a third strategy, in the storage medium, the control circuit 120 searches for the audio file in a directory whose name is similar to that of the directory where the still image file is stored. The order of applying the strategies can be properly arranged to achieve the best searching performance.

In Step 920, the control circuit 120 selectively plays back the audio file as the audio background during playing back of the still image file when the audio file exists in the storage medium. In particular, in a situation where the storage medium stores a plurality of still image files such as those stored in the aforementioned recordable/rewritable type optical disc, the control circuit 120 selectively plays back the audio file as the audio background during playing back of the still image files when the audio file exists in the storage medium.

According to this embodiment, the control circuit 120 provides a user interface, where the user interface allows the user to configure different schemes regarding playing back the audio background.

For example, according to a first scheme, the control circuit 120 automatically plays back the audio file as the audio background during playing back of the still image file(s) when the audio file exists in the storage medium.

In another example, according to a second scheme, when the audio file exists in the storage medium, the control circuit 120 prompts a user through the user interface to determine whether playing back the audio file as the audio background during playing back of the still image file is required. When a determination result from the user (e.g. a determination result received from a remote control of the audio/video player 100) indicates that playing back the audio file as the audio background during playing back of the still image file is required, the control circuit 120 plays back the audio file as the audio background during playing back of the still image file; otherwise, the control circuit 120 plays back the still image file without playing back the audio file as the audio background.

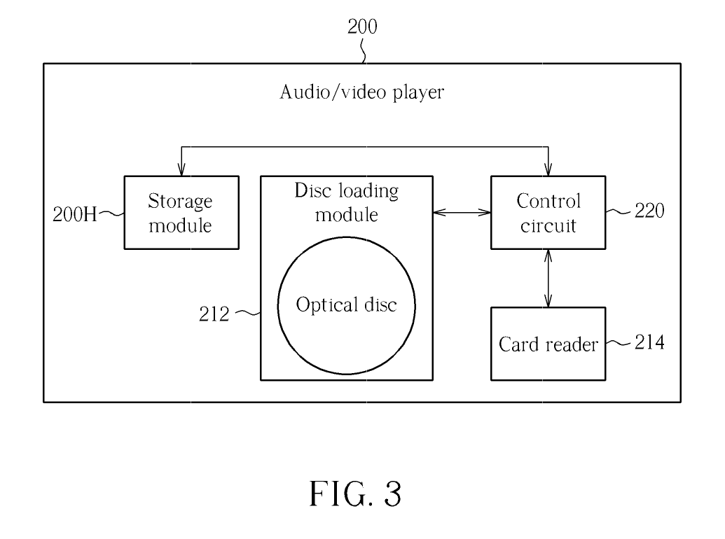

FIG. 3 is a diagram of an audio/video player 200 according to a second embodiment of the present invention. In this embodiment, the audio/video player 200 is a digital video recorder (DVR). The audio/video player 200 comprises a plurality of loading modules arranged to load a plurality of storage media into the audio/video player 200.

In this embodiment, the plurality of loading modules comprise a disc loading module 212 arranged to load an optical disc, such as the aforementioned recordable/rewritable type optical disc derived from the file backup process of the PC, into the audio/video player 200. In addition, the plurality of loading modules further comprise a card reader 214 arranged to load (or insert) a memory card into the audio/video player 200.

According to this embodiment, the audio/video player 200 further comprises a storage module 200H arranged to store a plurality of audio files, where the storage module 200H of this embodiment is a hard disc drive (HDD). In addition, the audio/video player 200 further comprises a control circuit 220 arranged to control operations of the audio/video player 200. The control circuit 220 is capable of controlling the audio/video player 200 to perform the aforementioned operations of the audio/video player 100, and is further capable of controlling the audio/video player 200 to perform other operations in accordance with the differences between the audio/video player 200 and the audio/video player 100.

For example, the control circuit 220 implemented according to this embodiment provides a user interface stronger than that in the first embodiment, where the user interface of this embodiment allows the user to configure different schemes regarding playing back the audio background, such as the first and the second schemes mentioned above, and further provides a third scheme.

According to the third scheme, when needed, the control circuit 220 can selectively play back one of the audio files stored in the storage module 200H as the audio background during playing back of the still image file.

Please note that there are two loading modules in the audio/video player 200 in this embodiment, i.e. the disc loading module 212 for loading the optical disc such as the aforementioned recordable/rewritable type optical disc derived from the file backup process of the PC, and the card reader 214. As a benefit of this architecture, when no audio file exists in a storage medium in a first module of the loading modules, the control circuit 220 prompts a user through the user interface to load another storage medium into the audio/video player 200 through a second module of the loading modules, in order to play back an audio file in the other storage medium (i.e. the storage medium that is loaded into the audio/video player 200 through the second of the loading modules) as the audio background during playing back of the still image file.

For example, in a situation where the first of the loading modules is the disc loading module 212 and the second of the loading modules is the card reader 214, when no audio file exists in the recordable/rewritable type optical disc, the control circuit 220 prompts the user through the user interface to load a memory card such as a security digital (SD) card into the audio/video player 200, in order to play back an audio file in the SD card as the audio background during playing back of the still image files in the recordable/rewritable type optical disc.

In another example, in a situation where the first of the loading modules is the card reader 214 and the second of the loading modules is the disc loading module 212, when no audio file exists in a memory card such as a mini SD card that stores the still image files as mentioned above, the control circuit 220 prompts the user through the user interface to load an optical disc such as an audio CD into the audio/video player 200, in order to play back an audio file in the audio CD as the audio background during playing back of the still image files in the mini SD card.

According to this embodiment, when needed, the control circuit 220 is capable of recording an audio file for being played back as the audio background during playing back of the still image file, where the control circuit 220 stores the recorded audio file with a filename similar to that of the still image file.

For example, a plurality of still image files is stored in a rewriteable type optical disc or a memory card, and the control circuit 220 stores a plurality of recorded audio files respectively corresponding to the still image files into the rewriteable type optical disc or a memory card.

In practice, the control circuit 220 controls the audio/video player 200 to play back the still image files, and allows the user to use a microphone coupled to the audio/video player 200 to read out audio comments respectively corresponding to the still image files at the same time. As a result, the control circuit 220 records audio comments as the recorded audio files. Similar descriptions for this embodiment are not repeated in detail here.

Those skilled in the art will readily observe that numerous modifications and alterations of the device and method may be made while retaining the teachings of the invention.

What is claimed is:

1. A method for controlling an audio/video player to play back audio background, the method comprising:
after a storage medium storing at least one still image file is loaded into the audio/video player, searching for an audio file corresponding to the still image file; and
selectively playing back the audio file as the audio background during playing back of the still image file when the audio file exists in the storage medium.

2. The method of claim 1, wherein the step of selectively playing back the audio file as the audio background during playing back of the still image file when the audio file exists in the storage medium further comprises:
automatically playing back the audio file as the audio background during playing back of the still image file when the audio file exists in the storage medium.

3. The method of claim 1, wherein the step of selectively playing back the audio file as the audio background during playing back of the still image file when the audio file exists in the storage medium further comprises:
when the audio file exists in the storage medium, prompting a user through a user interface to determine whether playing back the audio file as the audio background during playing back of the still image file is required; and
when a determination result indicates that playing back the audio file as the audio background during playing back of the still image file is required, playing back the audio file as the audio background during playing back of the still image file, otherwise, playing back the still image file without playing back the audio file as the audio background.

4. The method of claim 1, wherein the audio/video player comprises a storage module storing a plurality of audio files; and the method further comprises:
selectively playing back one of the audio files as the audio background during playing back of the still image file.

5. The method of claim 1, further comprising:
when no audio file exists in the storage medium, prompting a user through a user interface to load another storage medium into the audio/video player, in order to play back an audio file in the other storage medium as the audio background during playing back of the still image file.

6. The method of claim 1, wherein the audio/video player is an optical disc player or a digital video recorder (DVR).

7. The method of claim 1, wherein the storage medium is an optical disc or a memory card.

8. The method of claim 1, wherein the step of searching for the audio file corresponding to the still image file further comprises:
in the storage medium, searching for the audio file in a directory of a predetermined name; or
in the storage medium, searching for the audio file in a directory where the still image file is stored; or
in the storage medium, searching for the audio file in a directory whose name is similar to that of the directory where the still image file is stored.

9. The method of claim 1, further comprising:
recording an audio file for being played back as the audio background during playing back of the still image file; and
storing the recorded audio file with a filename similar to that of the still image file.

10. The method of claim 1, wherein the optical disc storing the still image file is a recordable/rewritable type optical disc derived from a file backup process of a personal computer (PC).

11. An audio/video player comprising:
at least one loading module arranged to load at least one storage medium into the audio/video player; and
a control circuit arranged to control operations of the audio/video player, wherein after a storage medium storing at least one still image file is loaded into the audio/video player, the control circuit searches for an audio file corresponding to the still image file, and the control circuit selectively plays back the audio file as audio background during playing back of the still image file when the audio file exists in the storage medium.

12. The audio/video player of claim 11, wherein the control circuit automatically plays back the audio file as the audio background during playing back of the still image file when the audio file exists in the storage medium.

13. The audio/video player of claim 11, wherein when the audio file exists in the storage medium, the control circuit prompts a user through a user interface to determine whether playing back the audio file as the audio background during playing back of the still image file is required; and
when a determination result indicates that playing back the audio file as the audio background during playing back of the still image file is required, the control circuit plays back the audio file as the audio background during playing back of the still image file, otherwise, the control circuit plays back the still image file without playing back the audio file as the audio background.

14. The audio/video player of claim 11, wherein the audio/video player further comprises a storage module storing a plurality of audio files; and the control circuit selectively plays back one of the audio files as the audio background during playing back of the still image file.

15. The audio/video player of claim 11, wherein when no audio file exists in the storage medium, the control circuit prompts a user through a user interface to load another storage medium into the audio/video player, in order to play back an audio file in the other storage medium as the audio background during playing back of the still image file.

16. The audio/video player of claim 11, wherein the audio/video player is an optical disc player or a digital video recorder (DVR).

17. The audio/video player of claim 11, wherein the storage medium is an optical disc or a memory card.

18. The audio/video player of claim 11, wherein in the storage medium, the control circuit searches for the audio file in a directory of a predetermined name; or in the storage medium, the control circuit searches for the audio file in a directory where the still image file is stored; or in the storage medium, the control circuit searches for the audio file in a directory whose name is similar to that of the directory where the still image file is stored.

19. The audio/video player of claim 11, wherein the control circuit records an audio file for being played back as the audio background during playing back of the still image file; and the control circuit stores the recorded audio file with a filename similar to that of the still image file.

20. The audio/video player of claim 11, wherein the optical disc storing the still image file is a recordable/rewritable type optical disc derived from a file backup process of a personal computer (PC).
